(19) United States
(12) Patent Application Publication
(10) Pub. No.: US 2024/0246466 A1
(43) Pub. Date: Jul. 25, 2024

(54) SEAT COVER

(71) Applicant: TOYOTA BOSHOKU KABUSHIKI KAISHA, Aichi-ken (JP)

(72) Inventors: Konomi OGATA, Miyoshi-shi (JP); Yutaro SUZUKI, Toyohashi-shi (JP); Miki IMAI, Nagoya-shi (JP)

(73) Assignee: TOYOTA BOSHOKU KABUSHIKI KAISHA, Aichi-ken (JP)

(21) Appl. No.: 18/416,206

(22) Filed: Jan. 18, 2024

(30) Foreign Application Priority Data
Jan. 24, 2023 (JP) 2023-008589

(51) Int. Cl. B60N 2/58

(52) U.S. Cl. CPC B60N 2/5891

(57) ABSTRACT

A seat cover is a skin material of a seat cushion or seatback. The seat cushion or seatback having a first seam allowance and a second seam allowance are sewn together with a first seam line. The first seam allowance is placed at a first end side of a first cover piece, and the second seam allowance is placed at a second end side of a second cover piece. At least one of a first design surface of the first cover piece or a second design surface of the second cover piece is provided with a plurality of stitches at positions crossing the first seam line.

### CROSS REFERENCE TO RELATED APPLICATION

This application is based on Japanese Patent Applications No. 2023-008589 filed on Jan. 24, 2023, the entire contents of which are incorporated herein by reference.

### TECHNICAL FIELD

The present disclosure relates to a seat cover. Specifically, the present disclosure relates to a seat cover having an outstitch and being capable of improving the appearance of the corners thereof.

### BACKGROUND ART

In the related art, a seat of a vehicle such as an automobile has an outstitch, which is a stitch for decoration, applied to a seat cover that covers the front surface thereof. The outstitch may be disposed at a corner, which is the frame and the boundary between the top cover of the seat cushion or the seatback. A seat cushion 100 illustrated in FIG. 7 has a cushion cover 110 which is a skin material covering the surface. The cushion cover 110 has a top cover 111 covering the seating surface and a frame 112 covering the side surface. In the first related art illustrated in FIG. 8, between the top cover 111 and the frame 112 in the seat width direction, the seam allowance 111a of the top cover 111 and the seam allowance 112a of the frame 112 are sewn together by an institch 113, which is a stitch that is not exposed in the appearance in a state where the surfaces are coupled. The seam allowance 111a and the sewn seam allowance 112a which are sewn together are sewn to the top cover 111 with an outstitch 114 while being in contact with the rear side 111b of the top cover 111. The cushion cover 110 thus formed is covered on a cushion pad 120 made of a foamed resin elastic body.

In the second related technique illustrated in FIG. 9, a seam allowance 111a of the top cover 111, a seam allowance 112a of the frame 112, and a fin 115b of a rigid piping 115 are sewn together by an institch 113 between the top cover 111 and the frame 112 in the seat width direction. At this time, the end of the fin 115b opposite to the head 115a of the piping 115 coincides with and is overlapped with the outer ends of the seam allowance 111a and the seam allowance 112a. The seam allowance 111a, the sewn seam allowance 112a and the piping 115 which are sewn together are sewn to the top cover 111 with an outstitch 114 while being in contact with the rear side 111b of the top cover 111. The cushion cover 110 thus formed is covered on the cushion pad 120 made of a foamed resin elastic body. JP2000-287780A discloses a seat cover in which the seam allowance 111a of the top cover 111 and the seam allowance 112a of the frame 112 are sewn to each other by an institch, without being provided with an outstitch.

In the first related technique described above, since the rigidity of the corner 121 of the cushion pad 120 is not so high, the shape of the corner of the seat cushion 100 is likely to be deformed when a force pulling the frame 112 of the covered cushion cover 110 away from the top cover 111 is applied, which adversely affects the appearance. In the second related technique, the rigidity of the piping 115 can prevent the shape of the corner of the seat cushion 100 from being likely to be deformed when applied with a force pulling the frame 112 away from the top cover 111, but increases the number of components. Furthermore, in all of the first prior art, the second prior art, and the prior art described in JP2000-287780A, the outstitch is either monotonous or is not provided, and the designability is insufficient.

In view of such a problem, an object of the present disclosure is to provide a seat cover in which the corner of the seat cushion or the seatback have excellent designability and is unlikely to be deformed.

### SUMMARY

In a first aspect of the disclosure, a seat cover is a skin material of a seat cushion or seatback. The seat cushion or seatback having a first seam allowance and a second seam allowance are sewn together with a first seam line. The first seam allowance is placed at a first end side of a first cover piece, and the second seam allowance is placed at a second end side of a second cover piece. At least one of a first design surface of the first cover piece or a second design surface of the second cover piece is provided with a plurality of stitches at positions crossing the first seam line.

According to the first aspect of the disclosure, since the plurality of stitches crossing the first seam line of the first cover piece and the second cover piece are formed, the rigidity of the cover piece in the vicinity of the first seam line is enhanced. When the seat cover is covered on the cushion body with the vicinity of the first seam line being aligned with the corner of the cushion body, the corner of the seat cushion or the seatback can be prevented from deformation. In addition, since the plurality of stitches cross the first seam line, the plurality of stitches is applied with a repulsive force by the regulation of the seam allowances, and the corner can be prevented from deformation more effectively. Further, the plurality of stitches can be changed in various ways to enhance the designability. The term “cross” includes both across the first seam line and starting from the first seam line, and the term “design surface” refers to a surface exposed in the appearance.

In a second aspect of the disclosure, the first seam allowance and the second seam allowance are sewn together, and then brought into contact with a rear side of the second cover piece and sewn to the second cover piece with a second seam line, the rear side being not a design surface.

According to the second aspect of the disclosure, since the second seam line is formed in addition to the first seam line and the plurality of stitches, the rigidity in the vicinity of the first cover piece and the second cover piece is enhanced, and the corner of the seat cushion or the seatback can be further prevented from deformation. Further, the addition of the second seam line, which can be visually recognized from the outside, can further enhance the designability.

In a third aspect of the disclosure, each length of the plurality of stitches extending from the first seam line are the same.

According to the third aspect of the disclosure, uniform rigidity is obtained along the extending direction of the first seam line, and the shape of the corner of the seat cushion or seatback can be prevented from partial deformation.

In a fourth aspect of the disclosure, the plurality of stitches are constituted using threads of a plurality of colors.

According to the fourth aspect of the disclosure, the appearance of the plurality of stitches can be changed, and the designability is enhanced.

In a fifth aspect of the disclosure, the plurality of stitches are formed continuously.

According to the fifth aspect of the disclosure, the rigidity is further enhanced along the extending direction of the first seam line, and the corner of the seat cushion or the seatback can be further prevented deformation.

### BRIEF DESCRIPTION OF DRAWINGS

FIG. 1 is a perspective view of a seat cushion covered with a seat cover according to an embodiment of the present disclosure.

FIG. 2 is a cross-sectional view taken along line II-II of FIG. 1. Regarding the decorative stitch 15, only a portion exposed in the appearance is illustrated.

FIG. 3 is a diagram illustrating the process of manufacturing the seat cover of the embodiment.

FIG. 4 is a diagram illustrating the process of manufacturing the seat cover of the embodiment.

FIG. 5 is a diagram illustrating the process of manufacturing the seat cover of the embodiment.

FIG. 6 is a view illustrating a plurality of stitches provided on the seat cover of the embodiment.

FIG. 7 is a perspective view of a seat cushion covered with a seat cover in the related art.

FIG. 8 is a cross-sectional view taken along line VIII-VIII of FIG. 7.

FIG. 9 is a view corresponding to FIG. 8 for explaining another seat cover of the related art.

### DESCRIPTION OF EMBODIMENTS

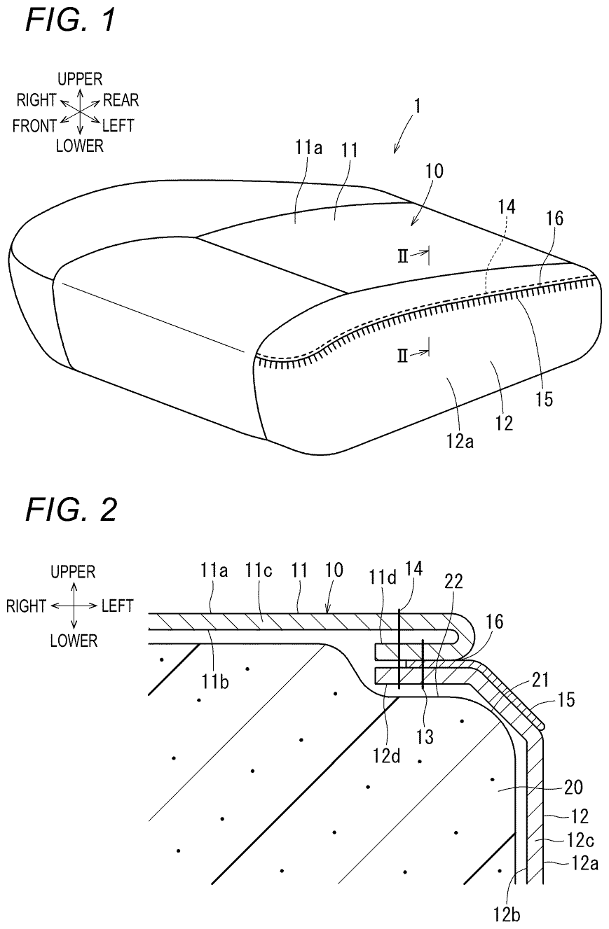

A cushion cover 10 according to an embodiment of the present disclosure will be described with reference to FIGS. 1 to 6. In the following description, the description of the directions will be made based on the directions of upper, lower, front, rear, left, and right indicated by arrows in the drawings. The upper, lower, front, rear, right, and left directions are based on a seated person when the seat cushion 1 covered with the cushion cover 10 is attached to an automobile. The left-right direction corresponds to the seat width direction. The cushion cover 10 corresponds to the “seat cover” in Claims.

As illustrated in FIGS. 1 and 2, a seat cushion 1, which is the seating portion of an automobile seat, is configured by covering a cushion pad 20, which is a cushion body placed on a cushion frame (not illustrated) forming a framework, with a cushion cover 10, which is a skin material. The cushion pad 20 is a foam molded body of urethane resin, and the outer shape thereof forms the outer shape of the seat cushion 1.

The cushion cover 10 includes a top cover 11 covering a seating surface and a frame 12 covering the front, rear, left, and right side surfaces. Both the top cover 11 and the frame 12 are formed by joining a plurality of pieces by sewing. Each piece is formed by joining a fabric on the front side and a thin rear base fabric made of tricot knit on the rear side into a planar body joined in layers with a urethane slab pad interposed therebetween, and cutting the planar body into a predetermined shape. As illustrated in FIG. 2, a front layer 11a of the top cover 11 and a front layer 12a of the frame 12 are fabrics, a rear layer 11b of the top cover 11 and a rear layer 12b of the frame 12 are rear base fabrics, and an intermediate layer 11c of the top cover 11 and an intermediate layer 12c of the frame 12 are urethane slab pads. Here, the frame 12 and the top cover 11 correspond to the “first cover piece” and the “second cover piece” in Claims, respectively.

As illustrated in FIG. 1, when the seat cushion 1 is viewed from the outside, a second seam line 14 extending in the front-rear direction in parallel with a boundary line 16 between the left side of the top cover 11 and the upper side of the left frame 12 is formed on the top cover 11 on the right side of the boundary line 16. A plurality of linear decorative stitches 15 extending obliquely leftward and downward are formed at equal intervals in the front-rear direction on the lower left side of the boundary line 16 of the left frame 12. For example, the dimension of the decorative stitches 15 extending leftward and downward from the boundary line 16 can be set to about 10 mm, and the dimension between the decorative stitches 15 in the front-rear direction can be set to about 5 mm, which are not limited thereto. The appearance of the upper left corner of the seat cushion 1 has high decoratability and high designability due to the presence of the second seam line 14 and the decorative stitches 15. Here, the decorative stitches 15 correspond to the “stitches” in Claims.

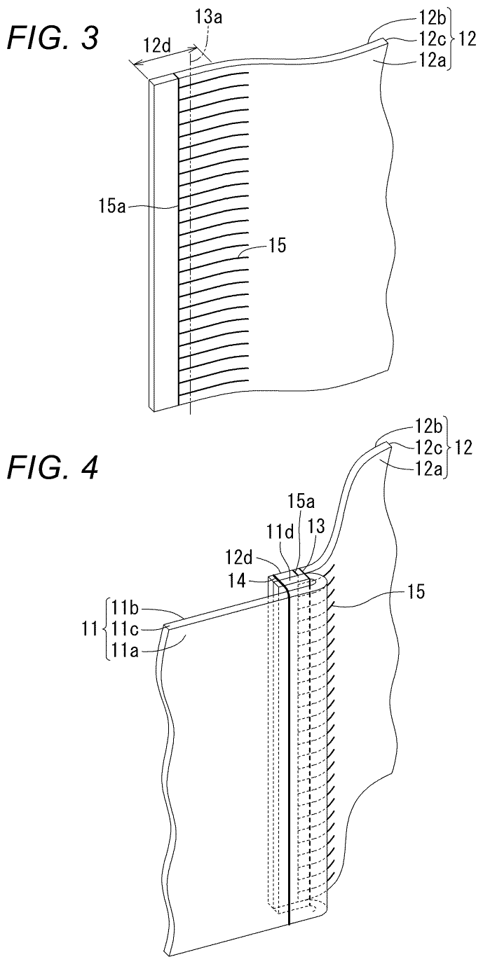

The sewing procedure of the portion of the cushion cover 10 corresponding to the upper left corner of the seat cushion 1 will be described. First, as illustrated in FIG. 3, the plurality of decorative stitches 15 are formed in the portion corresponding to the upper side of the left frame 12. The decorative stitches 15 are formed such that one end thereof extends across a first planned seam line 13a, which is a position to form the first seam line 13 to be sewn to the left side of the top cover 11 later. The decorative stitches 15 are coupled by a coupling stitch 15a extending in parallel with the first planned seam line 13a at the one end thereof. Accordingly, when the plurality of decorative stitches 15 are formed in the portion corresponding to the upper side of the left frame 12, the decorative stitches 15 are formed in a comb shape integrally with the coupling stitch 15a.

Next, as illustrated in FIG. 4, the left seam allowance 11d of the top cover 11 and the upper seam allowance 12d of the left frame 12 applied with the decorative stitches 15 are sewn together by the first seam line 13 in a state where the front layer 11a and the front layer 12a are brought into contact. Here, the first seam line 13 is a seam line not exposed in the appearance when the cushion pad 20 is covered with the cushion cover 10 to form the seat cushion 1, and is called an institch. Here, the seam allowance 12d and the seam allowance 11d correspond to the “first seam allowance” and the “second seam allowance” in Claims, respectively.

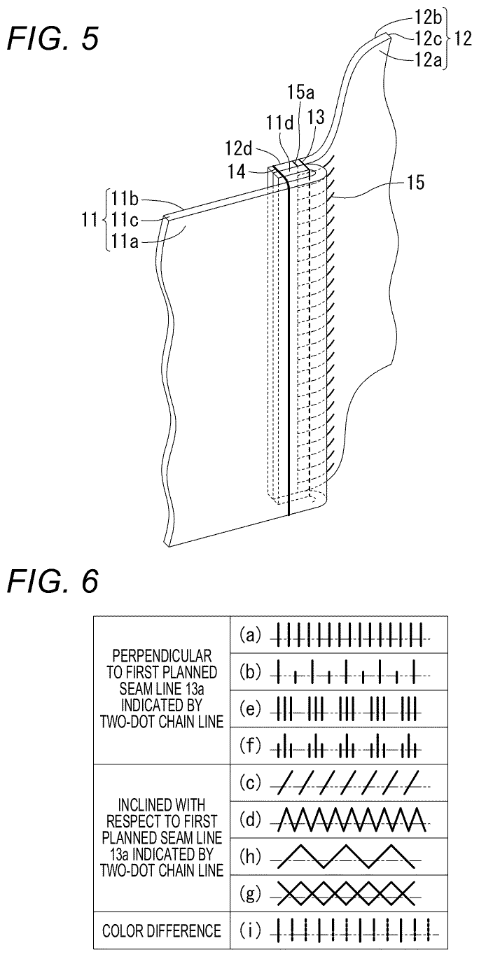

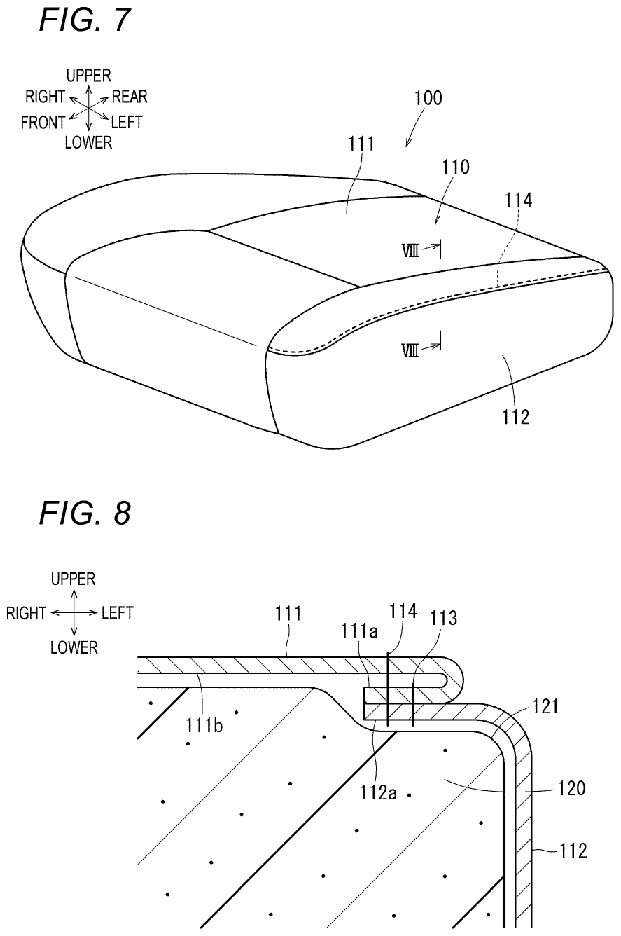

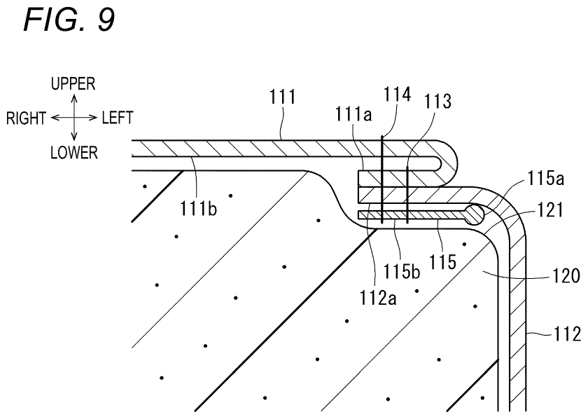

Finally, as illustrated in FIG. 5, the top cover 11 is folded back at the inner end of the seam allowance 11d so that the rear layer 11b of the seam allowance 11d and the rear layer 11b of the folded body are brought into contact. In this state, the seam allowance 11d and the seam allowance 12d sewn by the first seam line 13 are sewn to the body of the top cover 11 by the second seam line 14. The second seam line 14 is parallel to the first seam line 13 and is positioned between the first seam line 13 and the outer ends of the seam allowance 11d and the seam allowance 12d. Here, the second seam line 14 is a seam line exposed in the appearance when the cushion pad 20 is covered with the cushion cover 10 to form the seat cushion 1, and is called an outstitch.

When the cushion cover 10 thus formed is covered on the cushion pad 20 with the boundary line 16 aligned with the upper left corner 21 of the cushion pad 20, a state illustrated in FIG. 2 is obtained. The upper left corner 21 of the cushion pad 20 is pressed by the seam allowance 11d and the seam allowance 12d to form a recessed portion 22.

As illustrated in FIG. 6, the plurality of decorative stitches 15 can take various forms to improve the designability. For example, in (a) to (d), the decorative stitches 15 are a group extending vertically with respect to the first planned seam line 13a indicated by the two-dot chain line. In (a), the decorative stitches 15 have the same dimension extending vertically, and the intervals between the decorative stitches 15 are the same. In (b), the decorative stitches 15 have alternately long and short extending dimensions, and the intervals between the decorative stitches 15 are the same. In (c), the decorative stitches 15 are arranged in groups at long intervals, each group including three extending in the same dimension at short intervals. In (c), the decorative stitches 15 are arranged in groups at long intervals, each group including three extending in different dimensions at short intervals. In (e) to (h), the decorative stitches 15 are a group extending obliquely with respect to the first planned seam line 13a indicated by the two-dot chain line. In (e), the decorative stitches 15 have the same dimension extending obliquely, and the dimensions between the decorative stitches 15 are the same. In (f), the decorative stitches 15 are arranged in a zigzag shape at a short pitch with respect to the first planned seam line 13a. In (g), the decorative stitches 15 are arranged in a zigzag shape at a long pitch with respect to the first planned seam line 13a. In (g), the decorative stitches 15 are a combination of two groups, each arranged in a zigzag shape at a long pitch with respect to the first planned seam line 13a. In (i), the decorative stitches 15 of (a) or (b) each have a different color of the thread constituting the stitch.

The present embodiment configured as described above has the following effects. The rigidity in the vicinity of the first seam line 13, which is the coupling portion between the top cover 11 and the frame 12, is enhanced by forming the plurality of decorative stitches 15 crossing the first seam line 13. Accordingly, when the cushion cover 10 is covered on the cushion pad 20 with the vicinity of the first seam line 13 being aligned with the upper left corner 21 of the cushion pad 20, the corner 21 of the seat cushion 1 can be prevented from deformation even when applied with a force pulling the frame 12 downward. In addition, since the plurality of decorative stitches 15 cross the first seam line 13, the plurality of decorative stitches 15 are applied with a repulsive force by the regulation of the seam allowance 11d and the seam allowance 12d, and the corner 21 can be prevented from deformation more effectively. Further, the plurality of decorative stitches 15 are capable of changing the appearance of the seat cushion 1 in various ways to enhance the designability.

Further, since the second seam line 14 is formed in addition to the first seam line 13 and the plurality of decorative stitches 15, the rigidity in the vicinity of the first seam line 13 is further enhanced, and the corner of the seat cushion 1 can be further prevented from deformation even when applied with a force pulling the frame 12 downward. Further, the addition of the second seam line 14, which can be visually recognized from the outside, can further enhance the designability.

Furthermore, since the lengths extending from the first seam line 13 of the decorative stitches 15 are the same, uniform rigidity is obtained along the extending direction of the first seam line 13, and the shape of the corner 21 of the seat cushion 1 can be prevented from partial deformation. In addition, since the decorative stitches 15 are coupled by the coupling stitch 15a at the one end thereof, the rigidity is further enhanced along the extending direction of the first seam line 13, and the corner 21 of the seat cushion 1 can be further prevented from deformation. By changing the color of the threads constituting the decorative stitches 15, the appearance of the decorative stitches 15 can be changed, which can further enhance the designability. By changing the thickness of the threads constituting the decorative stitches 15, the rigidity feeling can be enhanced.

Although a specific embodiment has been described above, the present disclosure is not limited to the appearance and configuration thereof, and various modifications, addition, and deletion can be made without changing the gist of the present disclosure. For example, in the above-described embodiment, the present disclosure is applied to the seat cushion 1 provided in a seat for automobile, but the present disclosure is not limited thereto and may be applied to a seatback, or may be applied to a seat for a vehicle other than automobile, such as an aircraft, a ship, or a railway vehicle.

What is claimed is:

1. A seat cover which is a skin material of a seat cushion or seatback, the seat cushion or seatback having a first seam allowance and a second seam allowance sewn together with a first seam line, the first seam allowance being provided at a first end side of a first cover piece, the second seam allowance being placed at a second end side of a second cover piece, wherein
at least one of a first design surface of the first cover piece or a second design surface of the second cover piece is provided with a plurality of stitches at positions crossing the first seam line.

2. The seat cover according to claim 1, wherein
the first seam allowance and the second seam allowance are sewn together, and then brought into contact with a rear side of the second cover piece and sewn to the second cover piece with a second seam line, the rear side being not a design surface.

3. The seat cover according to claim 1, wherein
each length of the plurality of stitches extending from the first seam line are the same.

4. The seat cover according to claim 1, wherein
the plurality of stitches are constituted using threads of a plurality of colors.

5. The seat cover according to claim 1, wherein
the plurality of stitches are formed continuously.

6. The seat cover according to claim 1, wherein
the second seam allowance is sewn to the second cover piece with a second seam line in a state where the second seam allowance is sewn to the first seam allowance and in contact with a rear side of the second cover piece, the rear side being not a design surface.

7. The seat cover according to claim 6, wherein
the second cover piece is a top cover configured to cover a seating surface.

8. The seat cover according to claim 1, wherein
the first seam allowance and the second seam allowance are sewn together and form an integrated seam allowance, and the integrated seam allowance are sewn to the second cover piece with a second seam line.

9. The seat cover according to claim 8, wherein
the plurality of stitches is formed at the first end side on the design surface.

10. The seat cover according to claim 8, wherein
end portions of the stitches at the first end side are disposed between the first seam line and the second seam line.
